(19) United States
(12) Patent Application Publication
(10) Pub. No.: US 2014/0101583 A1
(43) Pub. Date: Apr. 10, 2014

(54) MOBILE TERMINALS AND METHODS OF OPERATING THE SAME

(71) Applicant: SAMSUNG ELECTRONICS CO., LTD., SUWON-SI (KR)

(72) Inventors: Sung-won JEONG, Suwon-si (KR); Yun-gun PARK, Seoul (KR)

(73) Assignee: SAMSUNG ELECTRONICS CO., LTD., Suwon-Si (KR)

(21) Appl. No.: 14/048,118

(22) Filed: Oct. 8, 2013

(30) Foreign Application Priority Data
Oct. 8, 2012 (KR) 10-2012-0111388

(51) Int. Cl. G06F 3/0481

(52) U.S. Cl. CPC G06F 3/04817
USPC 715/765

(57) ABSTRACT

A method of operating a mobile terminal may include receiving a first application via the mobile terminal; setting, on a first category page corresponding to characteristic information of the first application, an arrangement of an execution icon of the first application, wherein the first category page is among category pages of the mobile terminal that are defined in preset user setting information; and/or resetting the arrangement of the execution icon of the first application based on the preset user setting information, according to an arrangement period included in the preset user setting information.

### CROSS-REFERENCE TO RELATED APPLICATION(S)

This application claims priority from Korean Patent Application No. 10-2012-0111388, filed on Oct. 8, 2012, in the Korean Intellectual Property Office (KIPO), the entire contents of which are incorporated herein by reference.

### BACKGROUND

1. Field

Some example embodiments may relate to mobile terminals and/or methods of operating the same. Some example embodiments may relate to mobile terminals and/or methods of operating the same that may enhance convenience of use.

2. Description of Related Art

As the number of applications that are executed on mobile terminals increases, requests for providing convenience of use in order to enable users to execute applications more easily have increased.

### SUMMARY

Some example embodiments may provide mobile terminals and/or methods of operating the same that may enhance the convenience of use.

In some example embodiments, a method of operating a mobile terminal may comprise receiving a first application via the mobile terminal; setting, on a first category page corresponding to characteristic information of the first application, an arrangement of an execution icon of the first application, wherein the first category page is among category pages of the mobile terminal that are defined in preset user setting information; and/or resetting the arrangement of the execution icon of the first application based on the preset user setting information, according to an arrangement period included in the preset user setting information.

In some example embodiments, the preset user setting information may comprise category page information based on criterion that an execution icon of at least one application of a plurality of applications is arranged on a category page; arrangement order information based on criterion that an arrangement order of the execution icon of the at least one application of the plurality of applications in each of the category pages is set; and/or the arrangement period during which the category page information, the arrangement order information, or the arrangement order is updated.

In some example embodiments, the category page information may be set according to a category classification of an app store from which the at least one application of the plurality of applications is transmitted.

In some example embodiments, the category page information may be set to allow characteristic information of the at least one application of the plurality of applications to correspond to user-defined category pages.

In some example embodiments, the arrangement order information may be set according to a number of times and a length of time that the at least one application of the plurality of applications is used within the arrangement period, and according to weights that are respectively set for the number of times and the length of time that the at least one application of the plurality of applications is used.

In some example embodiments, the resetting of the arrangement of the execution icon of the first application may comprise changing the arrangement of the execution icon of the first application by arranging the execution icon of the first application from the first category page to a second category page, in response to the update of the category page information.

In some example embodiments, the resetting of the arrangement of the execution icon of the first application may comprise changing the arrangement of the execution icon of the first application by arranging the execution icon of the first application from a first position of the first category page to a second position of the first category page, in response to a change in arrangement order according to the arrangement order information.

In some example embodiments, the method may further comprise providing a setting interface to allow users to set the preset user setting information; and/or setting the preset user setting information in response to setting data input through the setting interface.

In some example embodiments, the method may further comprise arranging the execution icon of the first application on a temporary category page of the category pages of the mobile terminal if the first category page corresponding to the characteristic information of the first application is not defined in the preset user setting information; and/or moving the execution icon of the first application during the arrangement period.

In some example embodiments, the method may further comprise generating a subpage of the first category page if there is no space to arrange the execution icon of the first application on the first category page.

In some example embodiments, the method may further comprise changing the arrangement of the execution icon of the first application by a touch operation of a user, wherein if the execution icon of the first application is changed by the touch operation of the user, the resetting of the arrangement of the execution icon of the first application according to the preset user setting information is not performed.

In some example embodiments, a method of operating a mobile terminal may comprise downloading a first application; setting, in a first category folder corresponding to characteristic information of the first application, a location of an execution icon of the first application, wherein the first category folder is among category folders of the mobile terminal that are defined in preset user setting information; and/or resetting the location of the execution icon of the first application in the first category folder based on the preset user setting information, according to an arrangement period included in the preset user setting information.

In some example embodiments, the resetting of the location of the execution icon of the first application may comprise setting the location according to a number of times and a length of time that the first application is used during the arrangement period, and according to weights that are respectively set for the number of times and the length of time that the first application is used.

In some example embodiments, the method may further comprise setting, among category pages of the mobile terminal, a category page including each of the category folders, in the preset user setting information, according to a characteristic of the first category folder.

In some example embodiments, the method may further comprise changing the first category folder to a first category page if the first category folder includes a number of execution icons that is equal to or greater than a given number.

In some example embodiments, a method of operating a mobile terminal may comprise receiving or downloading a first application; setting, on a first category page or in a first category folder corresponding to characteristic information of the first application, an arrangement or location of an execution icon of the first application; and/or resetting the arrangement or the location of the execution icon of the first application based on the preset user setting information, according to an arrangement period included in preset user setting information. The first category page may be among category pages of the mobile terminal that are defined in the preset user setting information or the first category folder may be among category folders of the mobile terminal that are defined in preset user setting information.

In some example embodiments, the preset user setting information may comprise category page information; arrangement order information; and/or the arrangement period.

In some example embodiments, the category page information may be based on criterion that an execution icon of at least one application of a plurality of applications is arranged on a category page.

In some example embodiments, the arrangement order information may be based on criterion that an arrangement order of the execution icon of the at least one application of the plurality of applications in each of the category pages is set.

In some example embodiments, during the arrangement period, the category page information, the arrangement order information, or the arrangement order may be updated.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a flow chart of a method of operating a mobile terminal according to some example embodiments;

FIG. 2 is a view of a mobile terminal that operates in the same way as in FIG. 1;

FIG. 3 is a view of an operational example of a user setting information generating unit of FIG. 2;

FIG. 4 is a view of an example of a settings interface;

FIGS. 5 to 7 are views of examples of setting category page information;

FIG. 8 is a flow chart of a method of operating a mobile terminal according to some example embodiments;

FIG. 9 is a view of a structural example of an application processing unit of FIG. 2;

FIG. 10 is a view of an example in which icons to execute applications (referred to hereinafter as “execution icons of applications”) are arranged by the method of operating the mobile terminal of FIG. 1;

FIGS. 11 and 12 are views of examples in which the arrangement of the execution icons of applications is reset by using the method of operating the mobile terminal of FIG. 1; and

FIGS. 13 to 17 are views of the operating methods of mobile terminals according to some example embodiments.

### DETAILED DESCRIPTION OF THE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

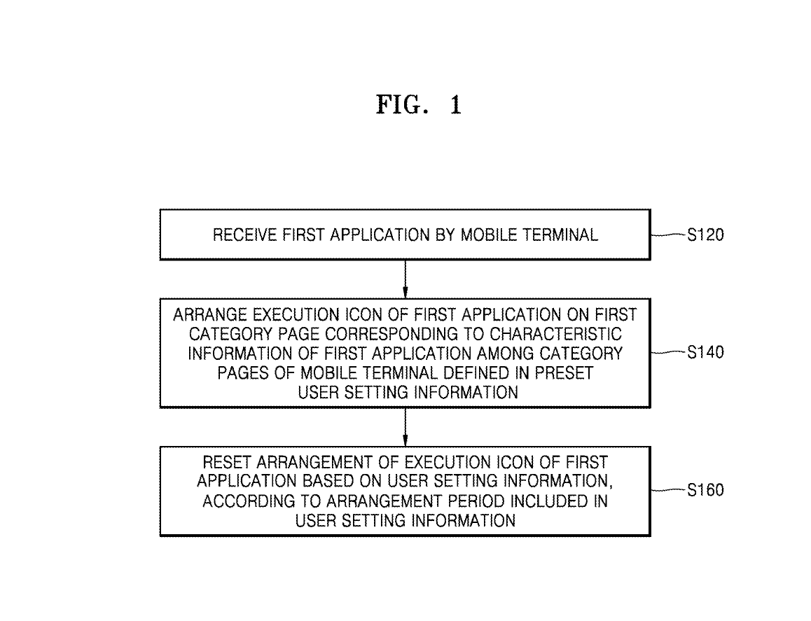

FIG. 1 is a flow chart of a method of operating a mobile terminal according to some example embodiments.

Referring to FIG. 1, the method of operating the mobile terminal according to some example embodiments includes receiving a first application via a mobile terminal in operation S120, arranging an execution icon of the first application on a first category page that corresponds to the characteristic information of the first application among the category pages of the mobile terminal that are defined in preset user setting information, in operation S140, and resetting the arrangement of the execution icon of the first application based on the preset user setting information according to an arrangement period included in the preset user setting information, in operation S160. For example, in operation S160, the resetting is performed per activating the arrangement period. A mobile terminal according to some example embodiments may be a smart phone, a mobile phone, a personal digital assistant (PDA), a laptop, a tablet computer, a media player, or a Global Positioning System (GPS) device.

The receiving of the first application via the mobile terminal in operation S120 may be simultaneously carried out while arranging the execution icon of the first application on the first category page in operation S140. For example, when there is a request for downloading the first application from an app store to a mobile terminal, the execution icon of the first application is arranged on the first category page on the basis of the characteristic information of the first application transmitted at the early stage of the downloading operation and then the rest of the first application may be downloaded. Alternatively, after the receiving of the first application via the mobile terminal in operation S120, the execution icon of the first application may be arranged on the first category page in operation S140. In this case, only the downloading status of the first application may be displayed on the display screen of the mobile terminal and, after the completion of the downloading operation, the execution icon may be generated on the first category page.

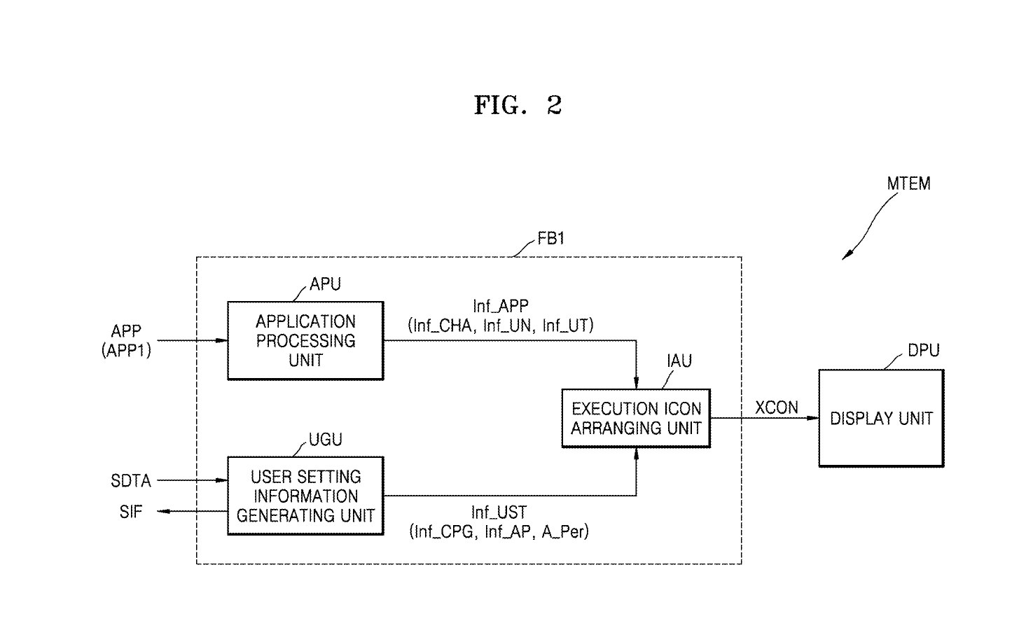

FIG. 2 is a view of a mobile terminal that operates in the same way as in FIG. 1.

Referring to FIG. 2, a mobile terminal MTEM according to some example embodiments may include a first functional block FB1 implementing the method of FIG. 2 and a display unit DPU that displays an execution icon of an application APP in response to a control signal XCON that is transmitted from the first functional block FB1. The first functional block FB1 of FIG. 2 may be implemented as a single functional block or as a plurality of functional blocks. In addition, the first functional block FB1 of FIG. 2 may be implemented in firmware or in a separate chip. Alternatively, the first functional block FB1 of FIG. 2 may be provided as a basic menu or implemented as an application. If implemented as the application, the first functional block FB1 of FIG. 2 may be implemented in such a way that it is downloaded and stored from the app store to the mobile terminal MTEM.

The first functional block FB1 may include a user setting information generating unit UGU, an application processing unit APU, and an execution icon arranging unit IAU.

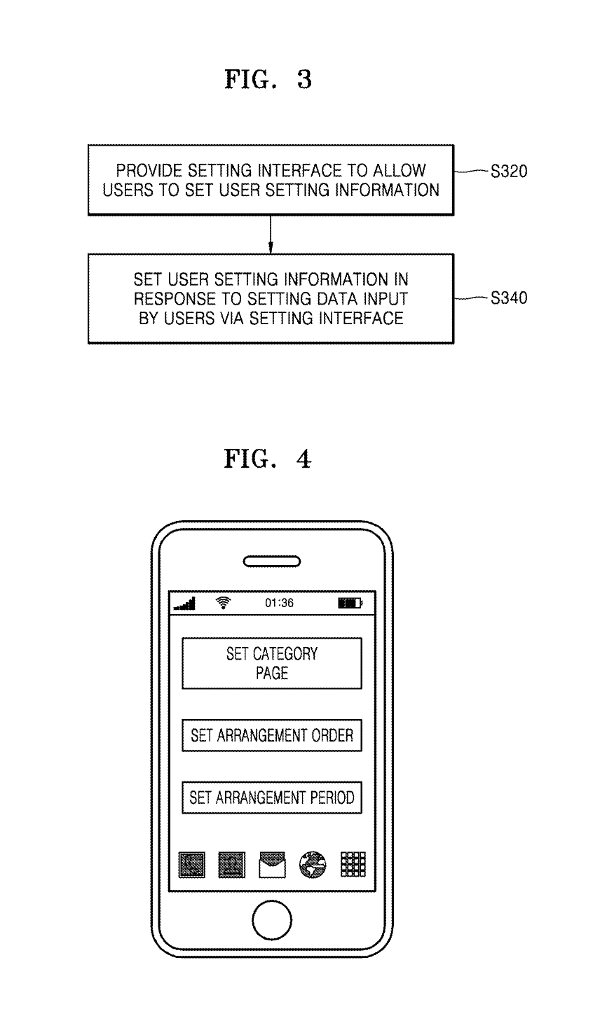

As illustrated in FIGS. 2 and 3, the user setting information generating unit UGU may provide a setting interface SIF to users in operation S320 and generate user setting information Inf_UST in operation S340 in response to setting data SDTA that is input by users via the setting interface SIF.

FIG. 4 is a view of an example of the setting interface SIF.

Referring to FIGS. 2 and 4, if the user setting information Inf_UST includes, for example, category page information Inf_CPG based on the criterion that the execution icon of any application APP is allocated to a category page, arrangement order information Inf_AP based on the criterion that the arrangement order of any application APP on each category page is set, and an arrangement period A_Per representing a period in which the category page information Inf_CPG or the arrangement order information Inf_AP is updated, the setting interface SIF may provide an interface through which users may input setting data SDTA for setting the category page, the arrangement order, and the arrangement period.

For example, the category page information Inf_CPG may be set to enable users to allocate, through an interface for setting a category page of the app store, the execution icon of any application APP to a category page corresponding to the category of an app store. The category page information Inf_CPG, set in this way, is transmitted to the execution icon arranging unit IAU.

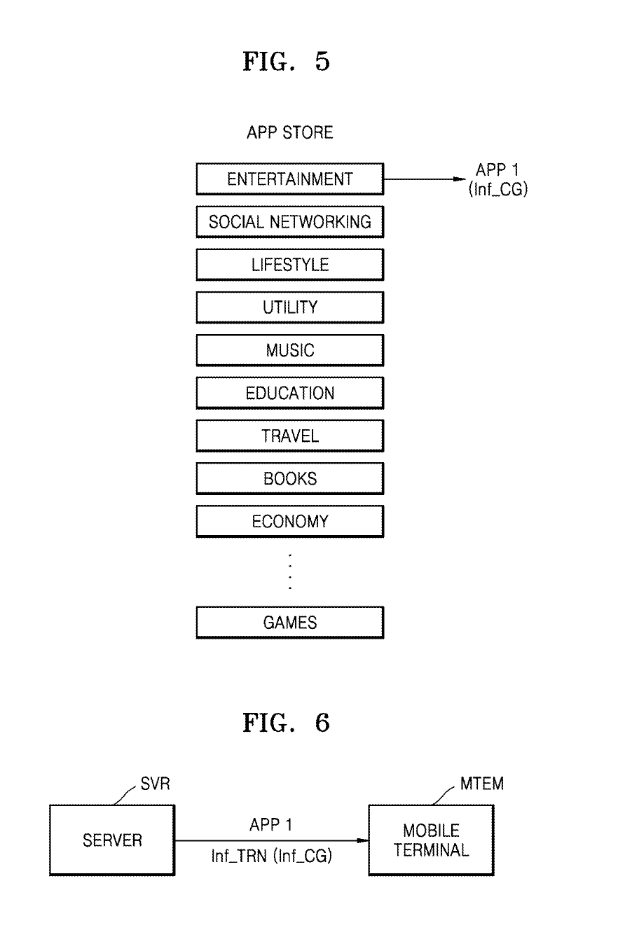

According to the category page information Inf_CPG, the execution icon arranging unit IAU may generate the control signal XCON on the basis of information regarding the category of an app store, from which a corresponding application (for example, a first application APP1) is downloaded. The control signal XCON is generated among application information Inf_APP input to the execution icon arranging unit IAU from the application processing unit APU. Additionally, the control signal XCON is generated so that the execution icon of the corresponding application is arranged on the category page corresponding to the category of the app store. For example, if the first application APP1 is downloaded from the entertainment category of an app store to the mobile terminal MTEM, the execution icon of the first application APP1 may be allocated to an entertainment page, as illustrated in FIG. 5.

The execution icon arranging unit IAU may further include a storage unit (not illustrated) that stores the control signal XCON set for each application. In addition, the display unit DPU may receive or store the control signal XCON and, thus, if users want to change display pages on the display screen of the mobile terminal MTEM through a touch operation, the display unit DPU may perform a control operation so that a category page corresponding to a corresponding display page is displayed.

Information on the categories Inf_CG of the app store of FIG. 5 may be included in characteristic information Inf_CHA of application information Inf_APP generated by the application processing unit APU. In this case, the Information on the categories Inf_CG including applications to be downloaded may be included in any application (for example, the first application APP1 itself) as in FIG. 5 or may be included in transmission information Inf_TRN that is transmitted along with a corresponding application when a server SVR transmits the corresponding application to the mobile terminal MTEM, as illustrated in FIG. 6.

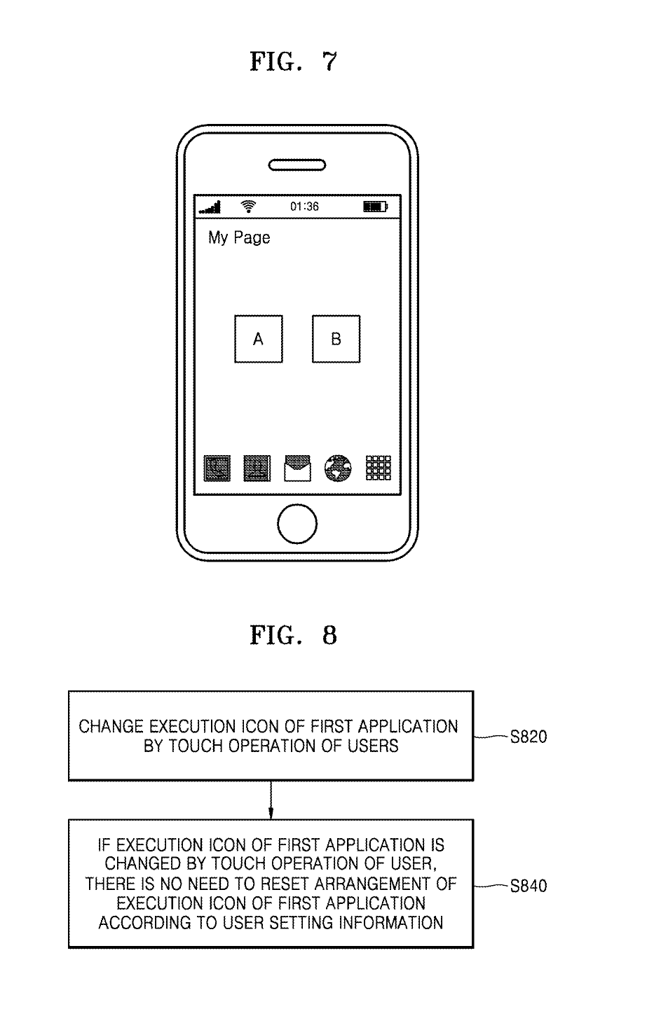

Unlike the example in FIG. 5, the category page information Inf_CPG may be set through the interface for setting a category page so that the execution icon of any application APP corresponds to a user-defined category page. For example, the category page information Inf_CPG may be set so that in the case of economy-related applications (for example, stocks, account books, prices, real estates, etc.), their execution icons are arranged on specific pages. For example, as illustrated in FIG. 7, for the execution icons of the economy-related applications A and B, the category page information Inf_CPG may be set to be allocated to My Page, for example.

According to the category page information Inf_CPG, the execution icon arranging unit IAU may generate the control signal XCON on the basis of characteristic information Inf_CHA of the application information Inf_APP input to the execution icon arranging unit IAU from the application processing unit APU. The control signal XCON is generated so that the execution icon of a corresponding application is arranged on the user-defined category page. For example, if it is determined through the characteristic information Inf_CHA of the applications APP A and APP B that the applications APP A and APP B are related to economy, the execution icon arranging unit IAU may generate the control signal XCON to allocate the applications APP A and APP B to My Page.

A method of operating a mobile terminal according to some example embodiments may change the arrangement of the execution icon of an application through a touch operation by a user in operation S820, as illustrated in FIG. 8. In this case, the resetting of the arrangement of the execution icon of the first application according to user setting information in operation S160 of FIG. 1 may be not provided, as indicated in operation S840. That is, in the method of operating a mobile terminal according to some example embodiments, users may arrange any application APP on a specific category page through a manual touch operation and, in this case, separate automatic rearrangement may not be performed on a corresponding application. However, example embodiments are not limited thereto, and the execution icon of an application arranged manually on a specific category page by users may also be changed with respect to an arrangement order within a corresponding page, according to an arrangement period. The detailed description related to this will be described below.

Referring back to FIGS. 2 and 4, the arrangement order information Inf_AP included in the user setting information Inf_UST may be generated to correspond to the number of times and the length of times that any application APP is used within the arrangement period A_Per, and to weights respectively set for the number of times and the length of time, by the setting data SDTA input through the arrangement order setting of the setting interface SIF. In addition, the arrangement period A_Per included in the user setting information Inf_UST may be set as a specific period such as a week, two weeks, or one month, by the setting data SDTA input through the arrangement period setting of the setting interface SIF.

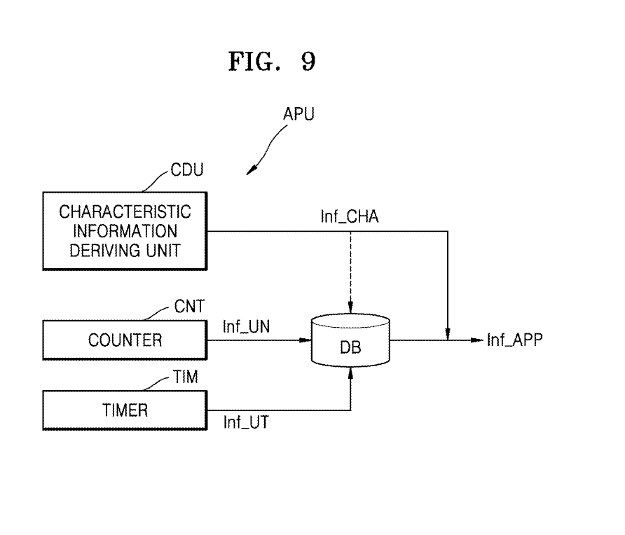

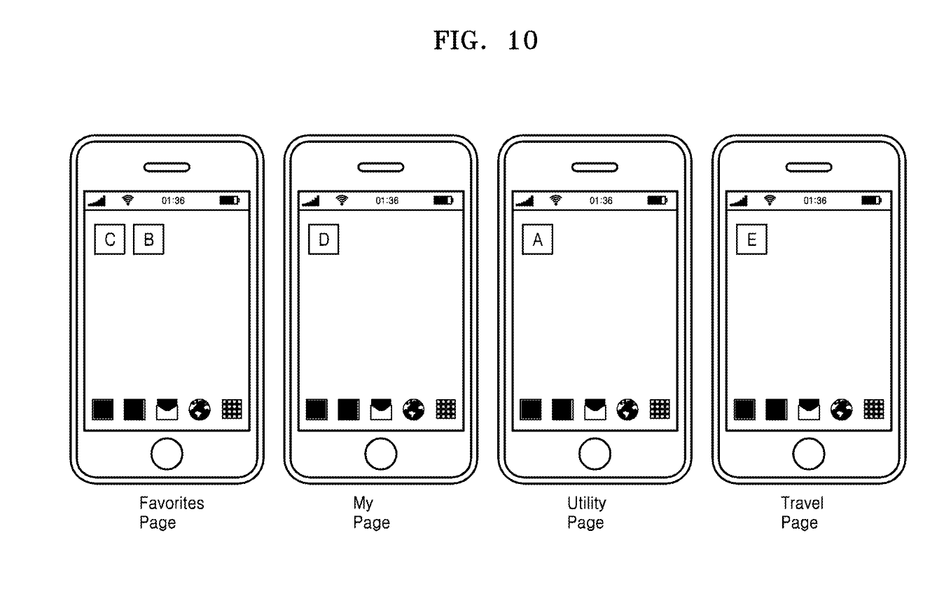

The application processing unit APU may generate the application information Inf_APP including the characteristic information Inf_CHA as described previously. The application information Inf_APP may also include information on the execution of a corresponding application (for example, first application APP1), for example, information on the number of times Inf_UN is executed and information on the length of times Inf_UT is executed. To this end, the application processing unit APU may include a characteristic information deriving unit CDU, a counter CNT, a timer TIM, and a database DB as in FIG. 9.

The characteristic information deriving unit CDU may derive the characteristic information Inf_CHA of an input application APP. The characteristic information Inf_CHA may be derived from setting data or metadata included in the application APP itself or from transmission data that is provided by a server downloading an application APP.

The counter CNT and the timer TIM may count the number of times that a specific application APP (for example, first application APP1) is executed, to generate the information on the number of times Inf_UN based on the number of times executed, and may calculate the length of time that the application is executed, to generate the information on the length of times Inf_UT on the length of time executed, respectively. Although not illustrated in FIGS. 2 and 9, it is possible to transmit, from the control logic of the mobile terminal MTEM to the counter CNT and the timer TIM, information related to the execution of a specific application.

The database DB may include the characteristic information Inf_CHA, the information on the number of times Inf_UN, and the information on the length of times Inf_UT. For example, the information on the number of times Inf_UN and the information on the length of times Inf_UT may be accumulated on the basis of a specific period (for example, arrangement period A_Per). The information stored in the database DB may be transmitted to the execution icon arranging unit IAU of FIG. 2 every arrangement period A_Per. However, the characteristic information Inf_CHA may not be stored in the database DB, but may instead be temporarily stored when an application is downloaded to a storage unit (for example, a register (not illustrated)) included in the characteristic information deriving unit CDU and then immediately transmitted to the execution icon arranging unit IAU of FIG. 2.

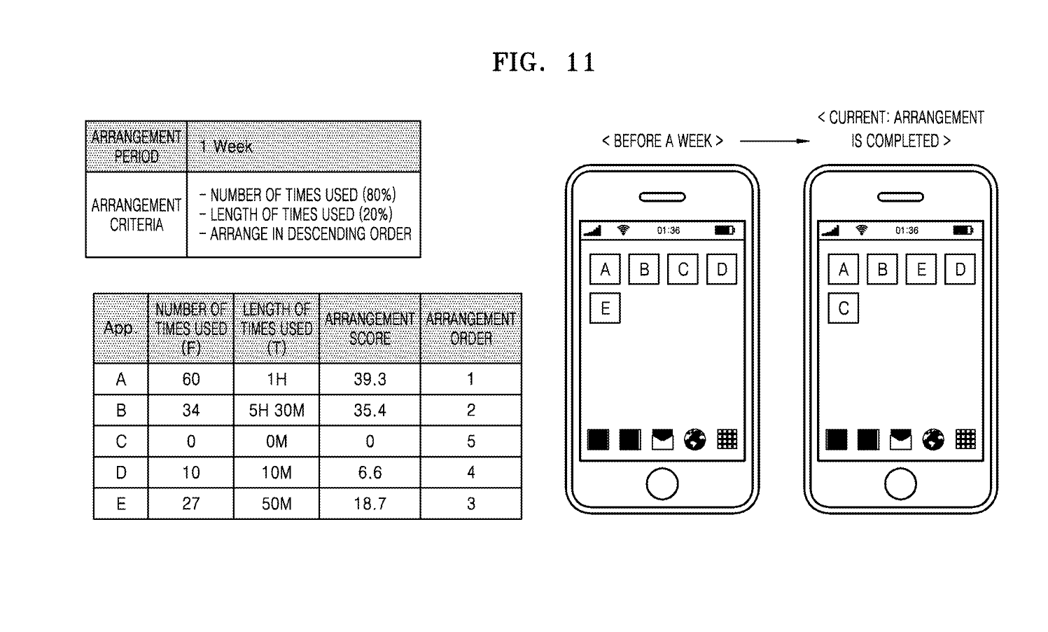

FIG. 10 is a view of an example in which execution icons of applications are arranged by the method of operating the mobile terminal described above.

Referring to FIG. 10, an example is illustrated in which the execution icons of applications APP C and APP B are arranged on the Favorites Page, the execution icon of application APP D is arranged on the My Page, the execution icon of application APP A is arranged on the Utility page, and the execution icon of application APP E is arranged on the Travel page. In this case, the execution icons of applications APP A and APP E respectively arranged on the Utility and Travel pages may correspond to when the user setting information Inf_UST is set so that a category page is allocated to correspond to the category of the app store of FIG. 5 described previously. Further, the execution icon of application APP D arranged on the My Page may correspond to when a category page is allocated in the same way as in FIG. 7. In addition, the execution icons of applications APP C and APP B arranged on the Favorites Page may correspond to when a category page is allocated through a manual touch operation by a user in the same way as in FIG. 8 described previously. However, example embodiments are not limited thereto, and the execution icon of an application may be allocated to a corresponding category page in another way different from the examples described above.

FIG. 11 is a view of an example in which the arrangement of the execution icons of applications is reset by using the method of operating the mobile terminal described above.

Referring to FIG. 11, in the case of the resetting of the arrangement of the execution icon of the first application according to user setting information in operation S160 of FIG. 1, it is possible to reset the arrangement by changing the execution icon of a corresponding application from a first location of a first category page to a second location thereof, according to a change in arrangement order during an arrangement period.

FIG. 11 illustrates an example in which the arrangement of applications APP C, APP D, and APP E is changed by a change in arrangement order of corresponding information during an arrangement period of one week. For example, the arrangement orders of the execution icons of applications APP A to APP E are respectively set to 1 to 5, and the execution icons of the applications APP A to APP E are sequentially arranged on a corresponding page. After an arrangement period of one week passes, the arrangement orders of the execution icons of applications APP C to APP E are respectively changed to 5, 4, 3, and the arrangement of the execution icons of the applications APP A to APP E is reset in the order of applications APP A, APP B, APP E, APP D, and APP C on the corresponding page.

FIG. 11 illustrates an example in which arrangement order information assigns a weight of 80% to the number of times an application is used and a weight of 20% to the length of time an application is used. Thus, the arrangement order described previously may be calculated. However, example embodiments are not limited thereto. For example, on the basis of the setting data SDTA of FIG. 2, the weight included in the arrangement order information may be set as another value different from the example described above, and a greater weight may be used for the length of time an application is used rather than for the number of times an application is used.

Users may change the weights for the number of times and the length of time an application is used, according to the characteristics of applications. For example, users may perform a setting operation so that the number of times an application is used has greater weight than the length of time an application is used with respect to applications that are frequently used by users but consume a relatively short amount of time, such as a traffic information application. Alternatively, users may perform a setting operation so that the length of time an application is used has greater weight than the number of times an application is used with respect to a game application.

The category page of FIG. 11 may be set in the same way as in FIG. 5 described previously or set in the same way as in FIG. 7 described previously.

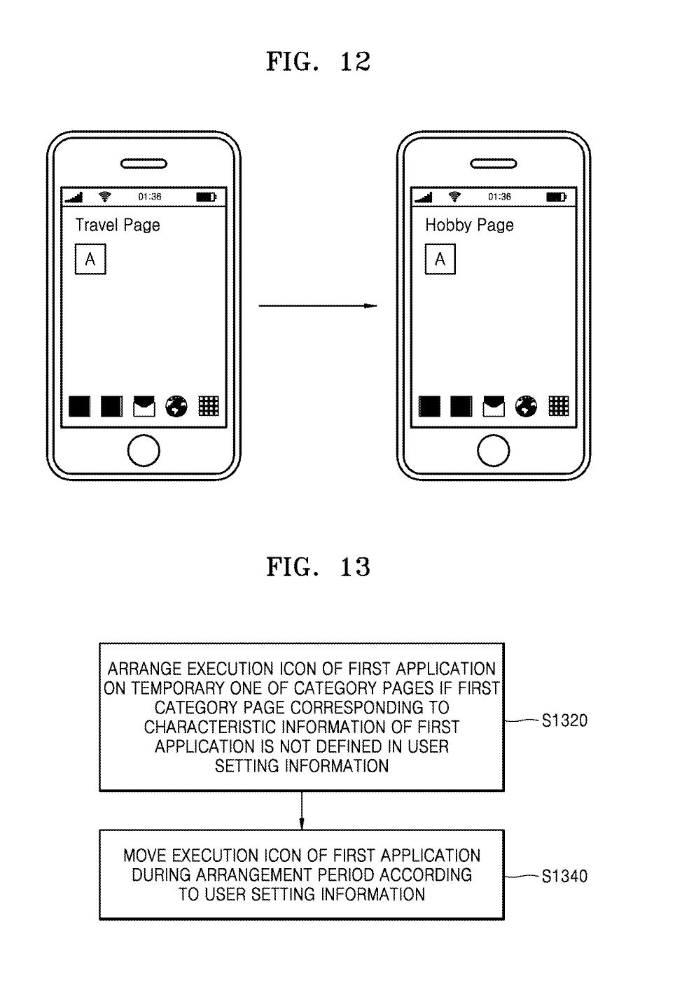

FIG. 11 illustrates an example of resetting the arrangement of execution icons according to the change of arrangement orders during an arrangement period, and FIG. 12 illustrates an example of changing and arranging the execution icon of a first application from a first category page to a second category page, according to the change or update of the category page information Inf_CPG of FIG. 2. For example, the execution icon of the application APP A arranged in the Travel page may be arranged in a Hobby page due to the change of the category page information Inf_CPG after any arrangement period passes. For example, if the category page information Inf_CPG is not set by users to correspond to the category of the app store as in the example of FIG. 5, but rather execution icons are arranged by user definition to change the category page information Inf_CPG as in the example of FIG. 7, the category page of the execution icon of the application APP A may be changed as in FIG. 12.

FIG. 13 is a view of a method of operating a mobile terminal according to some example embodiments.

Referring to FIG. 13, the method of operating the mobile terminal of FIG. 13 may add a few operations to the method of FIG. 1. That is, if a category page corresponding to a first application APP1 is not defined by user setting information, the execution icon of the first application APP1 may be arranged on a temporary category page in operation S1320, and the execution icon of the first application APP1 may move in response to a change of user setting information during any arrangement period in operation S1340. That is, if a specific application APP is downloaded although the criterion specifying how to arrange execution icon of the specific application APP has not yet been set, the operation method of the mobile terminal may first arrange that application APP on any category page. If the criterion specifying how to arrange the execution icon of the corresponding application APP is set during the next arrangement period, the execution icon may be moved to a corresponding category page.

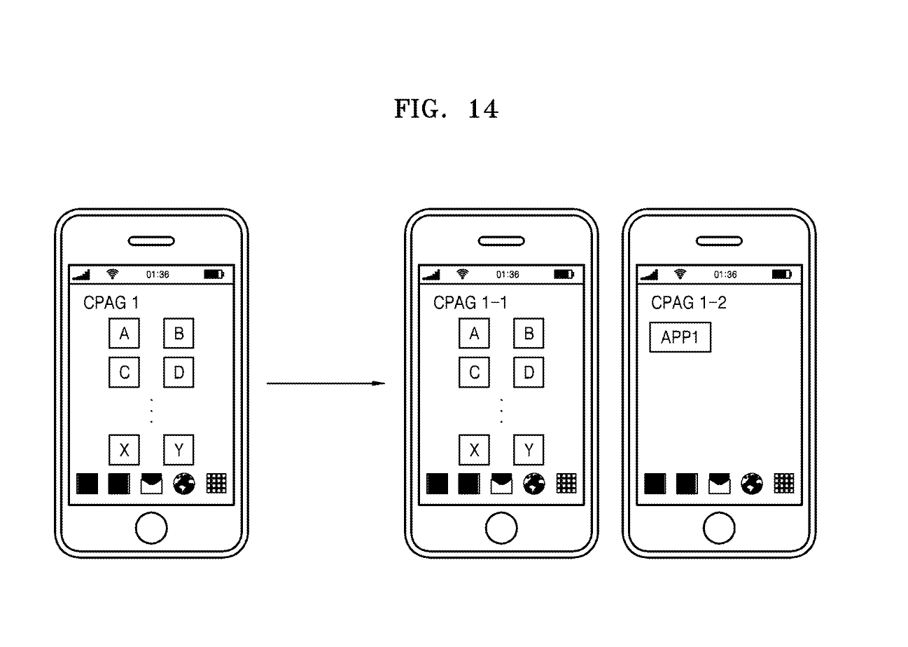

FIGS. 14 to 17 are views of examples of the operating methods of mobile terminals according to some example embodiments.

Referring first to FIG. 14, a few operations may be added to the method of operating the mobile terminal of FIG. 1. That is, it needs to arrange the execution icon of a first application APP1 on a first category page CPAG1 according to category page information, but there may be no space to arrange the execution icon of the first application APP1. For example, the first category page CPAG1 has a space on which Y execution icons may be arranged, and Y execution icons have already been arranged on the first category page CPAG1. In this case, if it needs to arrange the execution icon of the first application APP1, another first category page CPAG1 may be further generated.

In this case, as illustrated in FIG. 14, the first category page CPAG1 may be classified into two or more subpages, such as first category subpage CPAG1-1 and first category subpage CPAG1-2. Even if the first category page CPAG1 is classified into two or more subpages, such as first category subpage CPAG1-1 and first category subpage CPAG1-2, the setting of the arrangement order of FIG. 11 described previously may still be applied to the applications APPs of all subpages. Thus, although the execution icon of the first application APP1 is currently arranged in the first category subpage CPAG1-2 of the first category page CPAG1 in FIG. 14, it may be rearranged on the first category subpage CPAG1-1 of the first category page CPAG1 by a changed arrangement order during any arrangement period.

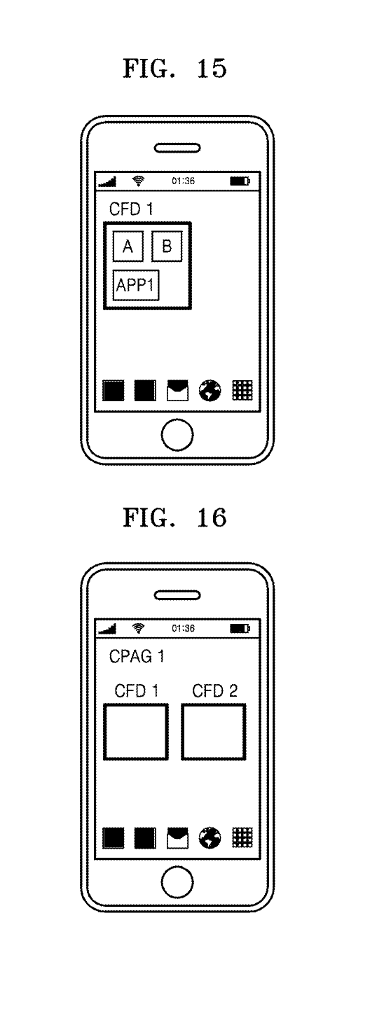

Referring to FIG. 15, the method of FIG. 15 relates to an example of arranging the execution icons of applications APPs into corresponding category folders. It differs from the method of operating the mobile terminal described above for arranging the execution icons of applications APPs into corresponding categories. For example, the method of FIG. 15 may arrange the execution icon of the first application APP1 into a first category folder CFD1 in response to the user setting information described previously. For example, the first category folder CFD1 of FIG. 15 may be a utility folder.

However, the mobile terminal does not necessarily include only category pages as in FIG. 1 or only category folders as in FIG. 15. The category folders and category pages may coexist on the mobile terminals.

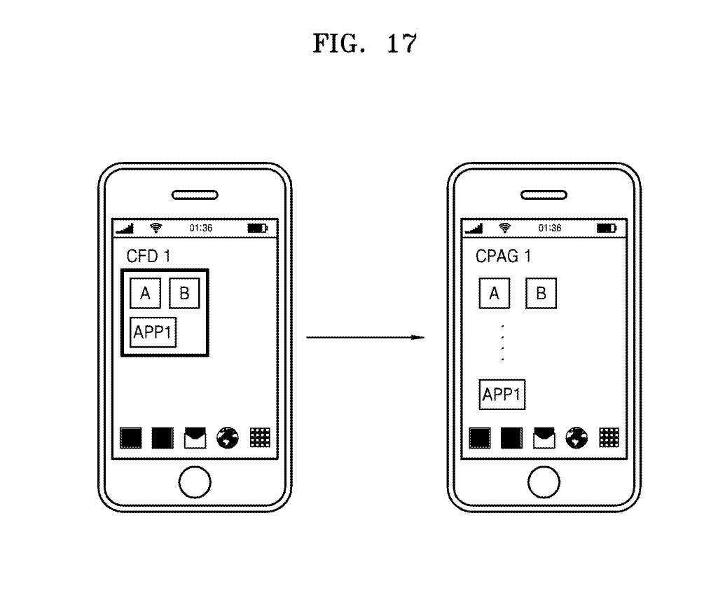

For example, as illustrated in FIG. 16, different category folders CFD1 and CFD2 may be included in the first category page CPAG1. For example, each category page may include category folders that are defined as having similar characteristics. For example, in FIG. 16, the first category page CPAG1 may be a Hobby page, the first category folder CFD1 may be a picture folder, and the second category folder CFD2 may be a travel folder.

Alternatively, if execution icons whose number is equal to or greater than a given number are arranged in the first category folder CFD 1, the first category folder CFD 1 may be changed to the first category page CPAG1, as illustrated in FIG. 17.

Hitherto, the best mode was disclosed in the drawings and specification. While specific terms were used, they were not used to limit the meaning or the scope of some example embodiments described in the claims, but merely used to explain some example embodiments. For example, although the method of operating the mobile terminal described above has calculated the arrangement order of execution icons within the same category page, the arrangement order may be calculated on the basis of an arrangement order diagram of each category page or information related to uses of the applications included in each category page. For example, although the Utility page is set as a display page prior to the Travel page, the Travel page may be rearranged as a display page prior to the Utility page if the total number and length of times used (to which weight may be applied) of all applications included in the Travel page are greater than those included in the Utility page.

While example embodiments have been particularly shown and described, it will be understood by those of ordinary skill in the art that various changes in form and details may be made therein without departing from the spirit and scope of the present invention as defined by the following claims.

What is claimed is:

1. A method of operating a mobile terminal, the method comprising:
receiving a first application via the mobile terminal;
setting, on a first category page corresponding to characteristic information of the first application, an arrangement of an execution icon of the first application, wherein the first category page is among category pages of the mobile terminal that are defined in preset user setting information; and
resetting the arrangement of the execution icon of the first application based on the preset user setting information, according to an arrangement period included in the preset user setting information.

2. The method of claim 1, wherein the preset user setting information comprises:
category page information based on criterion that an execution icon of at least one application of a plurality of applications is arranged on a category page;
arrangement order information based on criterion that an arrangement order of the execution icon of the at least one application of the plurality of applications in each of the category pages is set; and
the arrangement period during which the category page information, the arrangement order information, or the arrangement order is updated.

3. The method of claim 2, wherein the category page information is set according to a category classification of an app store from which the at least one application of the plurality of applications is transmitted.

4. The method of claim 2, wherein the category page information is set to allow characteristic information of the at least one application of the plurality of applications to correspond to user-defined category pages.

5. The method of claim 2, wherein the arrangement order information is set according to a number of times and a length of time that the at least one application of the plurality of applications is used within the arrangement period, and according to weights that are respectively set for the number of times and the length of time that the at least one application of the plurality of applications is used.

6. The method of claim 2, wherein the resetting of the arrangement of the execution icon of the first application comprises changing the arrangement of the execution icon of the first application by arranging the execution icon of the first application from the first category page to a second category page, in response to the update of the category page information.

7. The method of claim 2, wherein the resetting of the arrangement of the execution icon of the first application comprises changing the arrangement of the execution icon of the first application by arranging the execution icon of the first application from a first position of the first category page to a second position of the first category page, in response to a change in arrangement order according to the arrangement order information.

8. The method of claim 1, further comprising:
providing a setting interface to allow users to set the preset user setting information; and
setting the preset user setting information in response to setting data input through the setting interface.

9. The method of claim 1, further comprising:
arranging the execution icon of the first application on a temporary category page of the category pages of the mobile terminal if the first category page corresponding to the characteristic information of the first application is not defined in the preset user setting information; and
moving the execution icon of the first application during the arrangement period.

10. The method of claim 1, further comprising:
generating a subpage of the first category page if there is no space to arrange the execution icon of the first application on the first category page.

11. The method of claim 1, further comprising:
changing the arrangement of the execution icon of the first application by a touch operation of a user, wherein if the execution icon of the first application is changed by the touch operation of the user, the resetting of the arrangement of the execution icon of the first application according to the preset user setting information is not performed.

12. A method of operating a mobile terminal, the method comprising:
downloading a first application;
setting, in a first category folder corresponding to characteristic information of the first application, a location of an execution icon of the first application, wherein the first category folder is among category folders of the mobile terminal that are defined in preset user setting information; and
resetting the location of the execution icon of the first application in the first category folder based on the preset user setting information, according to an arrangement period included in the preset user setting information.

13. The method of claim 12, wherein the resetting of the location of the execution icon of the first application comprises setting the location according to a number of times and a length of time that the first application is used during the arrangement period, and according to weights that are respectively set for the number of times and the length of time that the first application is used.

14. The method of claim 12, further comprising:
setting, among category pages of the mobile terminal, a category page including each of the category folders, in the preset user setting information, according to a characteristic of the first category folder.

15. The method of claim 12, further comprising:
changing the first category folder to a first category page if the first category folder includes a number of execution icons that is equal to or greater than a given number.

16. A method of operating a mobile terminal, the method comprising:
receiving or downloading a first application;
setting, on a first category page or in a first category folder corresponding to characteristic information of the first application, an arrangement or location of an execution icon of the first application; and
resetting the arrangement or the location of the execution icon of the first application based on the preset user setting information, according to an arrangement period included in preset user setting information;
wherein the first category page is among category pages of the mobile terminal that are defined in the preset user setting information or wherein the first category folder is among category folders of the mobile terminal that are defined in preset user setting information.

17. The method of claim 16, wherein the preset user setting information comprises:
category page information;
arrangement order information; and
the arrangement period.

18. The method of claim 17, wherein the category page information is based on criterion that an execution icon of at least one application of a plurality of applications is arranged on a category page.

19. The method of claim 17, wherein the arrangement order information is based on criterion that an arrangement order of the execution icon of the at least one application of the plurality of applications in each of the category pages is set.

20. The method of claim 17, wherein during the arrangement period, the category page information, the arrangement order information, or the arrangement order is updated.
